(19) United States
(12) Patent Application Publication
(10) Pub. No.: US 2010/0141625 A1
(43) Pub. Date: Jun. 10, 2010

(54) DRIVING METHOD AND DRIVING CIRCUIT OF PLASMA DISPLAY PANEL HAVING A POTENTIAL BEING APPLIED TO AN ADDRESS ELECTRODE DURING A RESET PERIOD

(76) Inventors: Yuji SANO, Yokosuka (JP); Akihiro Takagi, Kawaguchi (JP); Tomokatsu Kishi, Yamato (JP); Toyoshi Kawada, Atsugi (JP); Yoshinori Okada, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/707,545

(22) Filed: Feb. 17, 2010

Related U.S. Application Data
(63) Continuation of application No. 11/319,168, filed on Dec. 28, 2005.

(30) Foreign Application Priority Data
Dec. 28, 2004 (JP) 2004-379643

(51) Int. Cl. G06F 3/038; G09G 3/28

(52) U.S. Cl. 345/208; 345/68

(57) ABSTRACT

In a driving method of a plasma display panel having a plurality of first electrodes provided so as to correspond to phosphors of a plurality of emitted light colors and having a plurality of second electrodes disposed so as to intersect with the first electrodes, the first electrodes for each of the emitted light colors that are provided so as to correspond to at least one of the phosphors of the emitted light colors among the first electrodes are brought into an electrically open state at the part of driving timings in a driving period. By doing so, gas discharge currents that flow through the first electrodes for each of the emitted light colors can be suppressed.

### CROSS-REFERENCE TO RELATED APPLICATION

The present application claims priority from U.S. patent application Ser. No. 11/319,168, filed Dec. 28, 2005, which claims priority from Japanese Patent Application No. JP 2004-379643 filed on Dec. 28, 2004, the content of which is hereby incorporated by reference into this application.

### TECHNICAL FIELD OF THE INVENTION

The present invention relates to a driving method and a driving circuit of a plasma display panel and to a plasma display device. More particularly, it relates to a driving method and a driving circuit of a plasma display panel and to a plasma display device which can improve the contrast by reducing background light emission.

### BACKGROUND OF THE INVENTION

Conventionally, AC-driven plasma display panels (Plasma Display Panel: PDP), which are one type of flat display devices, include a two-electrode type in which selective discharge (address discharge) and sustain discharge are performed with two electrodes (first electrode and second electrode) and a three-electrode type in which address discharge is performed by using a third electrode. electrodes) for performing sustain discharge are disposed on a first substrate (front glass substrate), and a third electrode (address electrode) is disposed on a second substrate (rear glass substrate) opposite to the first substrate. Moreover, noble gas is sealed between the first substrate and the second substrate, and when a voltage is applied between the electrodes, surface discharge occurs on the surface of a dielectric layer and a protective layer formed on the surface of the electrodes and ultraviolet rays are generated.

Phosphors of three primary colors, red (R), green (G), and blue (B) are coated on the inner surface of the second substrate. By exciting these phosphors with the ultraviolet rays for light emission, color display is performed. It should be noted that, in the surface discharge structure, each cell serving as a unit of light emitting element is formed in the region in which a pair of the sustain discharge electrode and the address electrode are orthogonally intersecting with each other.

FIG. 1 is a diagram schematically showing an example of a plasma display panel, in which a three-electrode surface-discharge AC plasma display panel is shown.

As shown in FIG. 1, sustain discharge electrodes X and Y are formed in parallel to each other on the inner surface of a front glass substrate 11 (on the side of a later-described rear glass substrate 16) so that one sustain discharge electrode X and one sustain discharge electrode Y are close to each other. The sustain discharge electrodes X and Y are comprised of transparent conductive films (transparent electrode) 12 forming surface discharge gaps and metal films (bus electrode) 13 overlapped on an edge part of the transparent electrodes, and are covered with a dielectric layer 14 and a protective layer 15.

Address electrodes A are formed in the direction orthogonal to the extending direction of the sustain discharge electrodes X and Y on the inner surface of the rear glass substrate 16 (on the side of the front glass substrate 11). The address electrodes A are covered with a dielectric layer 17, and on the front glass substrate 11 side of the dielectric layer 17, barrier ribs (rib) 18 which separate the discharge spaces are provided for each of the address electrodes A (for each column if the address electrode A extending in a direction is defined as a column).

Phosphors for emitting light of red (R), green (G), and blue (B) are disposed so that phosphors for each color are arranged and coated in a stripe shape on the surface of the front glass substrate 11 side of the dielectric layer 17 and side surfaces of the barrier ribs 18, thereby forming phosphor layers 19R, 19G, and 19B. The phosphor layers 19R, 19G, and 19B emit light when the layers are excited by the discharge between the sustain discharge electrodes X and Y. Note that “R”, “G”, and “B” in FIG. 1 indicate that the colors of the emitted light of the phosphors are red, green, and blue, respectively.

FIG. 2 is a block diagram schematically showing the entire configuration of an example of a plasma display device. In the description below, the cell emitting red light will be referred to as “cell-R”, the cell emitting green light will be referred to as “cell-G”, and the cell emitting blue light will be referred to as “cell-B”. Note that FIG. 2 shows the entire configuration of a plasma display device which is common to conventional technologies and the later-described present invention.

As shown in FIG. 2, a plasma display device (AC-driven plasma display device) 1 is provided with a PDP 2, an X driving circuit 3, a Y driving circuit 4, an address driving circuit 5, and a control circuit 6.

In the PDP 2, a plurality of cells serving as light emitting element units are disposed in a matrix. Note that the cell structure is the same as the above-described cell structure shown in FIG. 1. FIG. 2 shows an AC-driven PDP comprised of cells Cij (i and j are suffixes, wherein i=integer of 1 to n, and j=integer of 1 to m) disposed in a matrix of n rows and m columns.

In the PDP 2, as described above with reference to FIG. 1, X electrodes X1 to Xn and Y electrodes Y1 to Yn serving as sustain discharge electrodes are provided on a first substrate (front side) so as to be in parallel to each other, and address electrodes A1 to Am are provided on a second substrate (rear side) opposite to the first substrate in the direction orthogonal to the extending direction of the X electrodes X1 to Xn and the Y electrodes Y1 to Yn. The X electrodes X1 to Xn and the Y electrodes Y1 to Yn are disposed so that the X electrode and the Y electrode of each corresponding pair such as the pair of the X electrode X1 and the Y electrode Y1, the pair of the X electrode X2 and the Y electrode Y2, and so on are close to each other.

The X electrodes X1 to Xn are respectively connected to output terminals of the X driving circuit 3, the Y electrodes Y1 to Yn are respectively connected to output terminals of the Y driving circuit 4, and the address electrodes A1 to Am are respectively connected to output terminals of the address driving circuit 5.

The X driving circuit 3 is provided with a circuit for repeating discharge, and the Y driving circuit 4 is provided with a circuit for line sequential scanning and a circuit for repeating discharge. Moreover, the address driving circuit 5 is provided with a circuit for selecting the columns to be displayed. When the cells to be turned on are determined by the address driving circuit 5 and the circuit for the line sequential scanning of the Y driving circuit 4, and discharge is repeated by the circuits for repeating discharge of the X driving circuit 3 and the Y driving circuit 4, display operation of the PDP 2 is performed. The X driving circuit 3, the Y driving circuit 4, and the address driving circuit 5 are controlled by control signals which are fed from the control circuit 6.

The control circuit 6 detects display data D, horizontal synchronizing signals HS, and vertical synchronizing signals VS based on video signals VD fed from outside. Moreover, the control circuit 6 generates the above-mentioned control signals based on the detection results, and feeds the control signals to the X driving circuit 3, the Y driving circuit 4, and the address driving circuit 5.

FIG. 3 is a diagram showing driving voltage waveforms of an example of a conventional method of driving a plasma display panel (AC-driven PDP), in which a part corresponding to one sub-frame of a plurality of sub-frames constituting one frame is shown. One sub-frame (sub-frame period TSF) is divided into a reset period TR, an address period TA, and a sustain period (sustain discharge period) TS. Note that, in the description below, it is assumed that the negative charge is remaining in the X electrodes XE of the cells which are turned on in an immediately-before sustain period TS, and the positive charge is remaining in the Y electrodes YE of the same. Similarly, it is assumed that the positive charge is remaining in the X electrodes XE of the cells which are not turned on, and the negative charge is remaining in the Y electrodes YE of the same.

In the reset period TR, address electrodes AR, AG, and AB for selecting the cells for respectively emitting light of red, green, and blue are set to a ground level (0 V). Also, a voltage −Vxp′ is applied to all of the X electrodes (sustain discharge electrodes X) XE, and an obtuse wave in which the voltage is gradually raised so as to finally reach a voltage Vy′ is applied to all of the Y electrodes (sustain discharge electrodes Y). Note that the “obtuse wave” is a gradient waveform in which the voltage is continuously varied along with the time course over a sufficiently long period, in contrast to a waveform such as the later-described sustain pulse in which the voltage is varied in a short period of time.

When the voltages are applied to each of the electrodes in this manner, in each cell, the potential difference between the X electrodes XE and the Y electrodes YE (hereinafter, referred to as “between X-Y electrodes”) and the potential difference between the Y electrodes YE and the address electrodes AR, AG, and AB (hereinafter, referred to as “between Y-A electrodes”) reach firing voltage, and discharge between the X-Y electrodes and the Y-A electrodes is started. Accordingly, positive charges are written from the Y electrodes YE to the X electrodes XE and the address electrodes AR, AG, and AB.

Subsequently, after all of the X electrodes XE are set to the ground level (0 V), a voltage Vxa is applied to all of the X electrodes XE, and an obtuse wave in which the voltage is gradually lowered so as to finally reach a negative voltage is applied to all of the Y electrodes YE. Consequently, slight discharge is started between the electrodes in which the voltages exceed the firing voltage because of the voltages of wall charge itself accumulated in the electrodes. By virtue of the slight discharge, the wall charge accumulated in the electrodes is eliminated except for a part thereof.

As described above, in the reset period TR, the electrification state (wall charge formation state) of all of the cells in the PDP is equalized regardless of the state of remaining wall charge in the cells at the end of the immediately-before sustain period TS (when the reset period TR is started). Consequently, in the subsequent address period TA, address (write) discharge for selecting the ON-cells can be stably performed.

Subsequently, in the address period TA, address discharge is performed in a line sequential manner in order to select ON (turn on) and OFF (turn off) of the cells in accordance with display data such as video signals. In a state where all of the X electrodes XE and all of the Y electrodes YE are biased to predetermined potentials, a scan pulse (voltage −Vys) is sequentially applied to each of the Y electrodes YE corresponding to selected rows with using the Y electrodes YE as scanning electrodes. Concurrently with this row selection, address pulses (voltage Va) are applied to the address electrodes AR, AG, and AB corresponding to the selected cells which cause the address discharge (cells to be turned on during the sustain period TS).

Consequently, discharge is caused between the Y-A electrodes of the selected cells, which triggers the discharge between the X-Y electrodes of the selected cells. As a result, an amount of wall charge which enables the sustain discharge is accumulated in the X electrodes XE and Y electrodes YE of the selected cells. Thereafter, scan pulses are sequentially applied to Y electrodes YE in the same manner, and the above-described operations are repeated, thereby selecting ON (turn on) or OFF (turn off) of all of the cells of the PDP.

In the sustain period TS, sustain pulses (voltage Vs) are alternately applied to the X electrodes XE and the Y electrodes YE. Consequently, the sustain discharge corresponding to the display luminance is performed in the ON-cells by utilizing the wall charge formed in the address period TA.

Incidentally, in a conventionally proposed technology (for example, see Japanese Patent Application Laid-Open Publication No. 2003-271092 (Patent Document 1)), in order to improve display quality by reducing background light emission in a plasma display panel, the panel is driven so that a voltage is applied to the address electrodes for each light emission color based on the firing voltages between Y-A electrodes corresponding to the color of emitted light in at most (n-1) opposing electrode writing periods of a sub-frame, and the potential difference between the Y-A electrodes is controlled in accordance with the emitted light color of the cell. Thus, regardless of the emitted light color of the cell, the potential difference between the Y-A electrodes of the OFF-cell in an immediately-before sub-frame becomes an appropriate potential difference in accordance with the firing voltages, thereby preventing them from reaching the firing voltages, and reducing background light emission in a reset period.

Moreover, in another conventionally proposed technology (for example, see Japanese Patent Application Laid-Open Publication No. 2004-037883 (Patent Document 2)), in order to improve visibility of black display, an initialization period in which an initialization waveform (obtuse wave) having a rising part including a gradually increasing moderately inclined part and a falling part including a moderately inclined part which is gradually reduced to a voltage lower than the low-level voltage in the sustain period is applied to discharged cells which have been discharged in the sustain period is provided, and a period for generating slight discharge between sustain electrodes and scanning electrodes in all of the discharged cells is provided immediately before the arbitrary initialization period of one frame. In the above-described Patent Document 2, the electrification state of all the cells is equalized by means of the slight discharge in an AC-driven (three-electrode surface-discharge type) PDP having the above-described cell structure shown in FIG. 1.

### SUMMARY OF THE INVENTION

In the conventional driving method of an AC-driven PDP which has been described with reference to FIG. 3, at the point when the reset period TR is started, the polarity and amount of the wall charge remaining in the electrodes differ depending on the state, for example, whether the cell has been turned on or not in the immediately-before sub-frame.

Also, in AC-driven PDPs which can perform color (multicolor) display, as described above with reference to FIG. 1, at least three different phosphors for emitting light of red (R), green (G), and blue (B) are used in general. Therefore, the discharge characteristics of the cells differ depending on fineness of particles and dielectric constant of the materials of the phosphors, the width, filing rate (thickness), surface state of the phosphor layers, and others. Consequently, the firing voltages between the Y-A electrodes of the cells are different depending on the types of the phosphor layers, i.e., the emitted light colors of the cells.

However, as shown in FIG. 3, in the conventional driving method of an AC-driven PDP, the address electrodes AR, AG, and AB for the cells of R, G, and B have the same electric potential in the reset period TR. More specifically, in the conventional driving method of an AC-driven PDP, regardless of the state of the cells at the point when the reset period TR is started and the state of the phosphor layers (emitted light colors) of the cells, the same voltage is applied to the address electrodes AR, AG, and AB of all the cells of R, G, and B so that the potential differences between all of the Y-A electrodes (between Y-AR, Y-AG, and Y-AB electrodes) reach the highest firing voltage. Therefore, an unnecessarily high voltage is applied even to the address electrodes of the cells of the emitted light color not requiring the highest firing voltage, and power consumption of the address driving circuit is increased.

Moreover, in the cells for emitting light of a particular color having a firing voltage of the cell lower than the highest firing voltage, which are in the turned-off (OFF) state in the immediately-before sub-frame and are not supposed to emit light, the discharge is performed when the potential difference between the Y-A electrodes exceeds the firing voltage, and the light emission occurs in the regions which are not supposed to emit light in the display screen. This light emission is called “background light emission” which is one of the factors that deteriorate the contrast of the display.

An object of the present invention is to provide a driving method and a driving circuit of a plasma display panel and a plasma display device which can reduce the power consumption of the address driving circuit and improve contrast (improve display quality) by reducing background light emission of the display screen.

A first aspect of the present invention provides a driving method of a plasma display panel having a plurality of first electrodes provided so as to correspond to phosphors of a plurality of emitted light colors and having a plurality of second electrodes disposed so as to intersect with the first electrodes, wherein the first electrodes for each of the emitted light colors that are provided so as to correspond to at least one of the phosphors of the emitted light colors among the first electrodes are brought into an electrically open state at a part of a driving timing in a driving period.

A second aspect of the present invention provides a driving method of a plasma display panel having a plurality of first electrodes provided so as to correspond to phosphors of a plurality of emitted light colors and having a plurality of second electrodes disposed so as to intersect with the first electrodes, wherein wall charge generated in the first electrodes is independently controlled for each of the emitted light colors.

A third aspect of the present invention provides a driving circuit of a plasma display panel having a plurality of output terminals for driving a plasma display panel having a plurality of first electrodes provided so as to correspond to phosphors of a plurality of emitted light colors and having a plurality of second electrodes disposed so as to intersect with the first electrodes, wherein only driving elements connected to a plurality of the output terminals connected to the first electrodes for each of the emitted light colors in the driving circuit are controlled to be in a high-impedance state so that the first electrodes for each of the emitted light colors that are provided so as to correspond to at least one of the phosphors of the emitted light colors among the first electrodes are brought into an open state.

A fourth aspect of the present invention provides a plasma display device comprising: a plasma display panel having a plurality of first electrodes provided so as to correspond to phosphors of a plurality of emitted light colors and having a plurality of second electrodes disposed so as to intersect with the first electrodes, wherein the plasma display panel is driven by bringing the first electrodes for each of the emitted light colors that are provided so as to correspond to at least one of the phosphors of the emitted light colors among the first electrodes into an electrically open state at a part of a driving timing in a driving period.

A fifth aspect of the present invention provides a plasma display device comprising: a plasma display panel having a plurality of first electrodes provided so as to correspond to phosphors of a plurality of emitted light colors and having a plurality of second electrodes disposed so as to intersect with the first electrodes; and a driving circuit having a plurality of output terminals for driving the plurality of first electrodes, wherein the driving circuit controls only driving elements connected to a plurality of the output terminals connected to the first electrodes for each of the emitted light colors in the driving circuit to be in a high-impedance state so that the first electrodes for each of the emitted light colors that are provided so as to correspond to at least one of the phosphors of the emitted light colors among the first electrodes are brought into an open state.

According to the present invention, when driving a plasma display panel having a plurality of first electrodes provided so as to correspond to a plurality of phosphors of emitted light colors and a plurality of second electrodes disposed so as to intersect with the first electrodes, an output terminal provided so as to correspond to at least one of the phosphors of the emitted light colors in the first electrodes among the output terminals of a driving circuit of the first electrodes is brought into an electrically open state at a part of the driving timing in the driving period. In other words, driving elements connected to the output terminal constituting a driving circuit of the first electrodes are controlled to be in a shutoff state at a part of the driving timing in the driving period.

Consequently, gas discharge currents that flow only through the first electrodes can be suppressed, and wall charge accumulated only in the first electrodes can be controlled to an optimal charge amount. As a result, the output voltage and power consumption of the address driving circuit can be reduced, and the background light emission in the PDP can be also reduced.

According to the present invention, the power consumption of an address driving circuit of a plasma display panel can be reduced, and display quality can be improved by reducing the background light emission.

### BRIEF DESCRIPTIONS OF THE DRAWINGS

FIG. 1 is a diagram schematically showing an example of a plasma display panel;

FIG. 2 is a block diagram schematically showing the entire configuration of an example of a plasma display device;

FIG. 3 is a diagram showing driving voltage waveforms of an example of a conventional method of driving a plasma display panel;

FIG. 4 is a diagram showing driving voltage waveforms in a first embodiment of the driving method of the plasma display panel according to the present invention;

FIG. 5 is a diagram for describing examples of operations of an address driving circuit;

FIG. 6 is a block diagram showing an example of a general address driving circuit;

FIG. 7 is a block diagram showing an example of the address driving circuit in the plasma display device according to the present invention;

FIG. 8 is a diagram showing driving voltage waveforms in a second embodiment of the driving method of the plasma display panel according to the present invention;

FIG. 9 is a diagram showing driving voltage waveforms in a third embodiment of the driving method of the plasma display panel according to the present invention;

FIG. 10A is a voltage waveform diagram showing another example of an obtuse waveform;

FIG. 10B is a voltage waveform diagram showing another example of an obtuse waveform; and

FIG. 11 is a diagram showing actual measurement examples of the address driving voltages in the plasma display device according to the present invention.

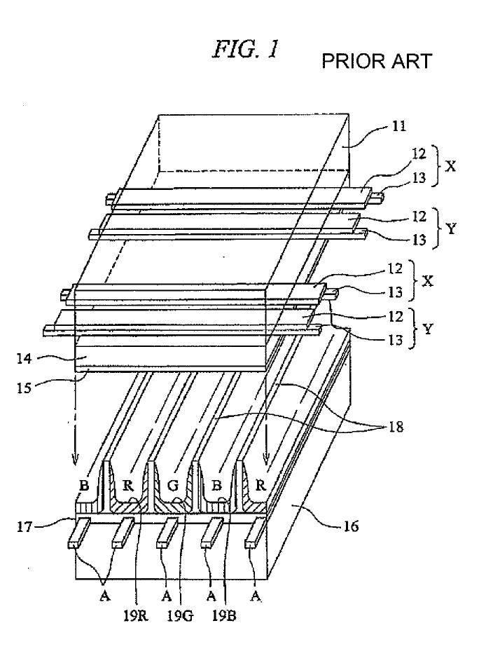

### DESCRIPTIONS OF THE PREFERRED EMBODIMENTS

Hereinafter, embodiments of a driving method and a driving circuit of a plasma display panel and a plasma display device according to the present invention will be described in detail with reference to appended drawings.

### Embodiments

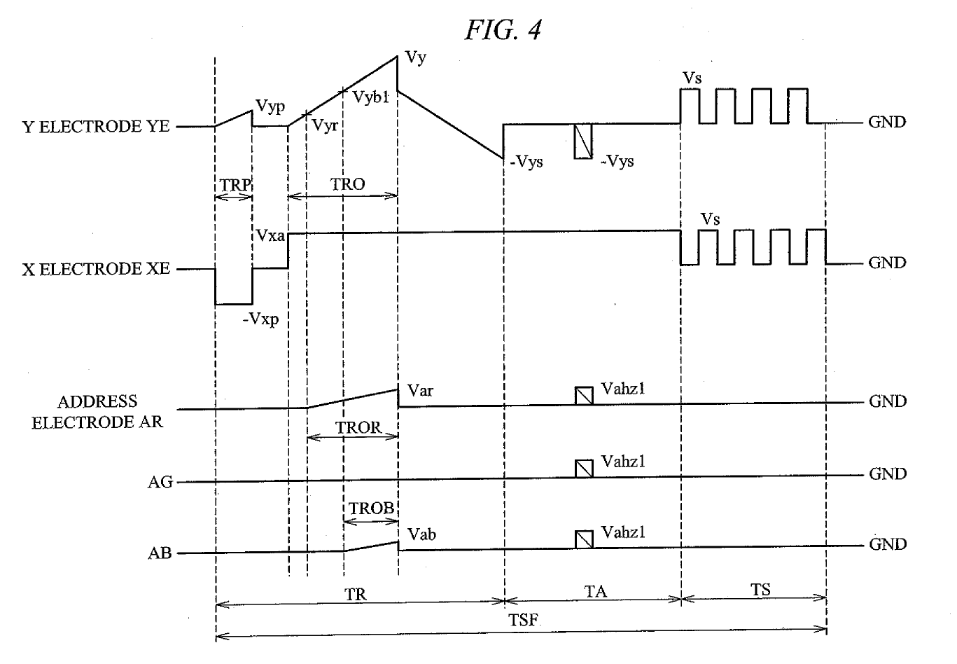

FIG. 4 is a diagram showing driving voltage waveforms in a first embodiment of the driving method of the plasma display panel according to the present invention, wherein driving voltage waveforms in a period (sub-frame period TSF) corresponding to the display of one sub-frame image among a plurality of sub-frame images constituting an image of one frame are shown.

In FIG. 4, firing voltages between Y-A electrodes in accordance with the emitted colors (phosphor layers) of the cells are assumed to be in the order of red(R)<blue(B)<green(G). A firing voltage Vfb between Y-AB electrodes of a B-cell is lower than a firing voltage Vfg between Y-AG electrodes of a G-cell by a voltage Va1 (Va1>0), and a firing voltage Vfr between Y-AR electrodes of a R-cell is lower than the firing voltage Vfg between Y-AG electrodes of a G-cell by a voltage Va2 (Va2>Va1).

Vfg=Vfb+Va1=Vfr+Va2

Va2>Va1>0

As described above, one sub-frame period TSF is divided into a reset period TR, an address period TA, and a sustain period TS. Note that, in the description below, it is assumed that, at the point when the reset period TR is started, negative charge is remaining in X electrodes XE of the ON-cells which have been turned on in the immediately-before sustain period TS, and positive charge is remaining in Y electrodes YE of the same. Similarly, it is also assumed that positive charge is remaining in the X electrodes XE of the OFF-cells which have not been turned on, and negative charge is remaining in the Y electrodes YE of the same.

As shown in FIG. 4, first, in an in-plane electrode writing period TRP for performing reset between in-plane electrodes in the reset period TR, a voltage −Vxp is applied to all of the X electrodes XE, and an obtuse wave in which the voltage is gradually increased so as to finally reach a voltage Vyp is applied to all of the Y electrodes YE. In this period, all of address electrodes AR, AG, and AB are at a ground level (0 V). In the in-plane electrode writing period TRP, the same voltage is applied to all of the X electrodes XE and the Y electrodes YE as the voltage −Vxp or Vyp applied to the X electrodes XE or the Y electrodes YE since the firing voltage Vfp between the X-Y electrodes is not varied depending on the emitted light colors of the cells.

In this case, the voltages −Vxp and Vyp have voltage values which cause the potential difference between the X-Y electrodes of the cells which have been turned on in the immediately-before sub-frame to be higher than the firing voltage Vfp and cause the potential difference between the X-Y electrodes of the cells which have not been turned on to be lower than the firing voltage Vfp, due to the contribution of the wall charge formed in the X electrodes XE and the Y electrodes YE in accordance with the state (ON/OFF) of the cells in the immediately-before sub-frame SF.

Consequently, discharge between the X-Y electrodes is sequentially started in the cells in which the potential difference between the X-Y electrodes has reached the firing voltage Vfp among the cells which have been turned on in the immediately-before sub-frame, and positive charge is written from the Y electrodes YE to the X electrodes XE.

Subsequently, all of the X electrodes XE and the Y electrodes YE are set to the ground level (0 V), and then, reset between the opposing electrodes is performed in an opposing electrode writing period TRO. In the driving method of the plasma display panel of the first embodiment, in the opposing electrode writing period TRO, the potentials (open state) of the address electrodes AR, AG, and AB of the R-cells, G-cells, and B-cells of respective colors are independently controlled.

More specifically, in the opposing electrode writing period TRO for performing reset between the opposing electrodes, the address electrode AR of the R-cell (cell for emitting red light) is controlled to be in the open state only during a period TROR, and the address electrode AB of the B-cell (cell for emitting blue light) is controlled to be in the open state only during a period TROB. The address electrode AG of the G-cell (cell for emitting green light) is always maintained at the ground level (0 V) during the opposing electrode writing period TRO.

By virtue of the control described above, the potentials of the address electrodes AR and AB increase under the influence of electrostatic induction from the Y electrodes YE after attaining the open state. Herein, slight discharge is suppressed at the point when the potential differences between the address electrodes AR and AB and the Y electrodes YE are increased from zero to Vyr and Vyb1, respectively. Consequently, the positive wall charge accumulated in the address electrodes AR and AB are suppressed to the charge amounts which are respectively corresponding to Vyr and Vyb1, and charge accumulation and light emission more than necessary are suppressed.

Actually, some slight discharge is added between the address electrodes AR and AB and the Y electrodes YE based on the charge of electrostatic capacitance which is parasitic between the address electrodes and the Y electrodes YE and other peripheral AC ground points. Therefore, attained potentials Var and Vab of the address electrodes AR and AB are sometimes somewhat varied in accordance with the display state in the previous sub-field.

By virtue of the control described above, the variation between the address electrodes AR, AG, and AB of the cells of corresponding colors in the maximum values and minimum values of address driving voltages which are required for the driving can be suppressed to a small amount. Moreover, when the variation of the address driving voltages between the address electrodes AR, AG, and AB of the cells of corresponding colors is suppressed, the wall charge finally accumulated in all of the address electrodes can be further increased through the optimization of an attained potential of the obtuse wave (−Vys) of the Y electrodes YE. As a result, an address driving voltage Vahz1 which is common in the address electrodes AR, AG, and AB in the subsequent address period TA can be reduced in comparison with conventional Va.

Moreover, although an example of the driving waveform in which the waveform of the obtuse wave voltage is applied to the Y electrodes YE so as to cause slight discharge has been shown in FIG. 4, it goes without saying that similar effects can be obtained also in the case of the driving waveform in which the waveform of the obtuse wave voltage is applied to the X electrodes XE by applying the present embodiment for controlling the open state of the address electrodes of the cells for each of the emitted light colors.

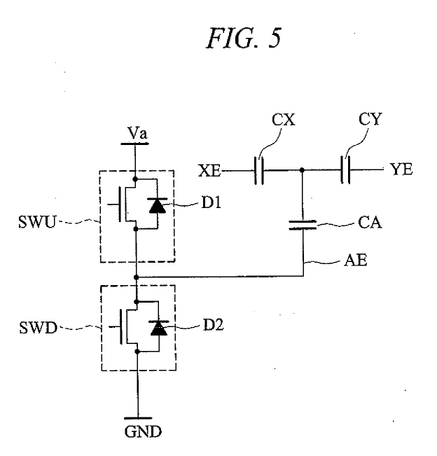

FIG. 5 is a diagram for describing the operation examples of the address driving circuit, and is used for describing the operations of the address driving circuits which drive the address electrodes AR, AG, and AB in accordance with the above-described driving voltage waveforms of FIG. 4. In FIG. 5, reference symbols XE, YE, and AE represent the X electrode, the Y electrode, and the address electrode (AR, AG, or AB), respectively, and CX, CY, and CA schematically represent capacitances which are formed by, for example, dielectric layers of the X electrode, the Y electrode, and the address electrode, respectively.

Each of switches SWU and SWD is comprised of a semiconductor element such as a MOSFET, IGBT, or a bipolar transistor. Note that FIG. 5 shows the case where MOSFETs are used for the switches SWU and SWD, and diodes D1 and D2 are parasitic.

One end of the switch SWU is connected to a voltage supply which supplies a voltage Va, and one end of the switch SWD is connected to a ground (GND). The other end of the switch SWU is connected to the other end of the switch SWD, and the address electrode AE is connected to the mutual connection point thereof. Note that the circuit shown in FIG. 5 is an individual circuit at least for each of the address electrodes AR, AG, and AB, and the switches SWU and SWD can be individually controlled for each of the address electrodes AR, AG, and AB.

In the circuit shown in FIG. 5, when the switch SWU is turned ON and the switch SWD is turned OFF, the voltage Va is applied to the address electrode AE, and inversely when the switch SWU is turned off and the switch SWD is turned on, the address electrode AE becomes a ground level. Moreover, when both of the switches SWU and SWD are turned off, the address electrode AE is in an open state (high-impedance state).

Therefore, in order to realize the driving waveforms shown in FIG. 4, if the switches SWU of the address electrodes AR, AG, and AB are in an OFF state and the switches SWD thereof are in an ON state at the point when the opposing electrode writing period TRO is started, first, the switch SWD of the address electrode AR is turned off in the period TROR, and the switch SWD of the address electrode AB is also turned off in the period TROB. By adjusting the timing and time for turning off the switches SWD, the wall charge to be accumulated in the address electrodes can be individually controlled in the above-described manner.

Also, the highest value of the electrostatic induction potential in each address electrode in the open state shown in FIG. 4 is Var or Vab. However, in the case where the MOSFET is used for the switch SWU or in the case where the diode D1 is added thereto, when the OFF time of the switch SWD is sufficiently increased, the highest potential of each address electrode is clipped to the voltage Va in FIG. 5. Although a slight discharged current flows again through the diode D1 during this clipping period, even when the clipping occurs, no deterioration is caused in the above-described effects of the present invention because the reduced amount of accumulated wall charge of each address electrode in the open state with respect to other address electrodes before the clipping is maintained. Note that the influence in the above-described clipping operation is similarly exerted also in the case where the MOSFET is used for the switch SWD at the time when the electrostatic induction potential is reduced to the ground level described later or the case where the diode D2 is added thereto, and no deterioration due to the clipping is caused.

Then, after the opposing electrode writing period TRO, the switches SWD of the address electrodes AR and AB are controlled to be in an ON state again to maintain the potentials of the electrodes to the GND level. When the switches SWU and SWD of the address electrodes AR and AB are appropriately controlled, and the address electrodes AR and AB are set to be in the open state at appropriate timing, the wall charge amounts accumulated in the address electrodes AR, AG, and AB of the cells of each of the emitted light colors can be individually controlled.

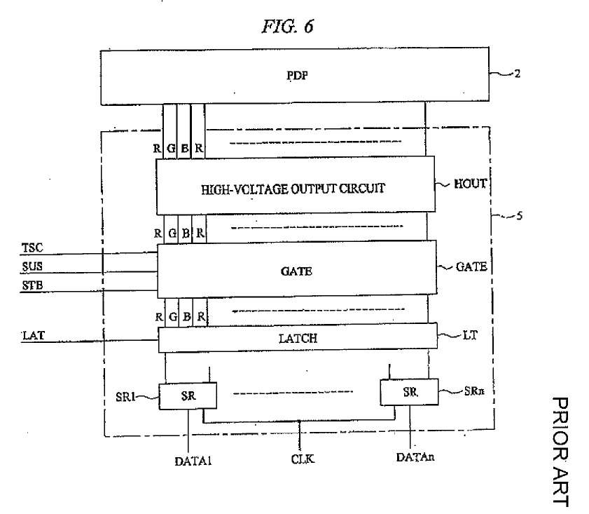

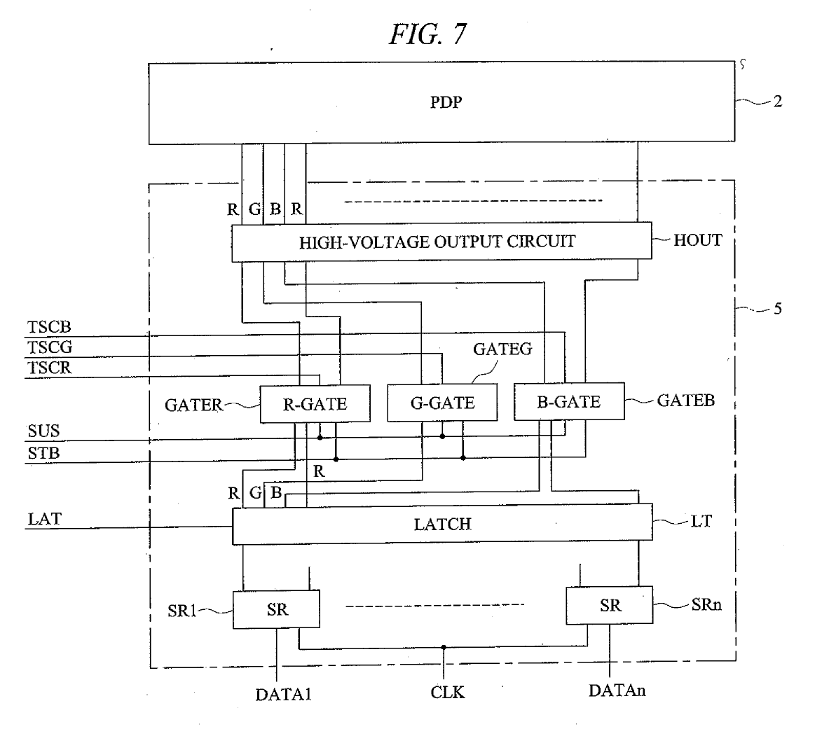

FIG. 6 is a block diagram showing an example of a general address driving circuit, and FIG. 7 is a block diagram showing an example of the address driving circuit in the plasma display device according to the present invention. An embodiment of the address driving circuit for realizing the driving method of the AC-driven PDP which has been described with reference to FIG. 4 will be described with reference to FIG. 6 and FIG. 7.

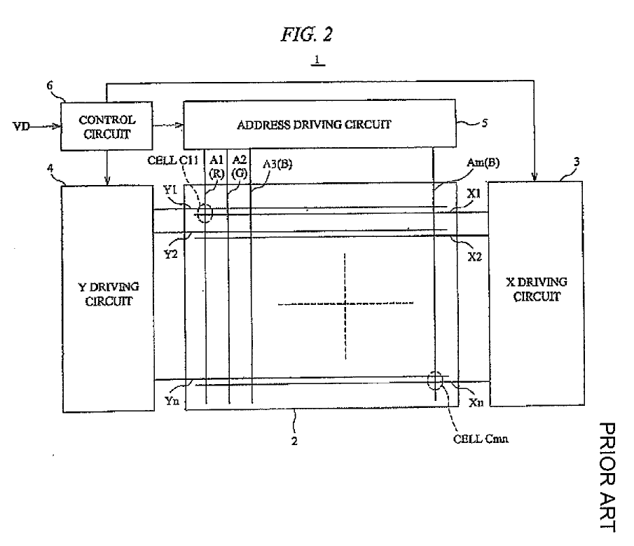

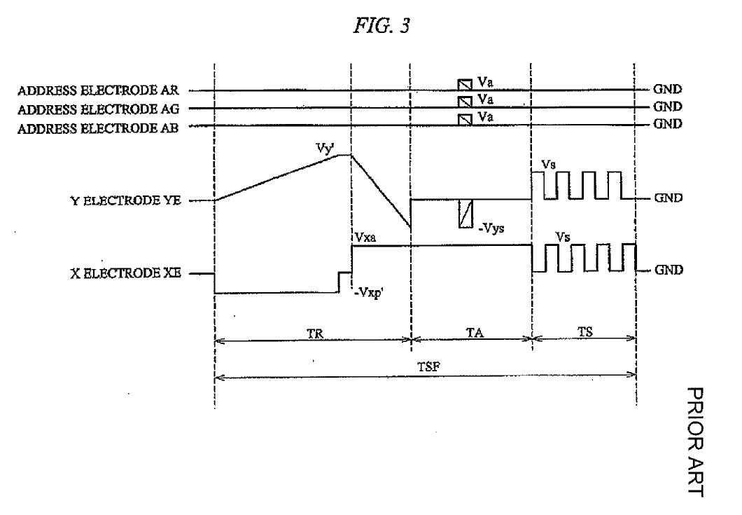

As shown in FIG. 6, in a conventional address driving circuit 5 for driving the PDP 2, shift register circuits SR1 to SRn take the display data signals DATA1 to DATAn fed from an unillustrated control circuit (control circuit 6 in FIG. 2) in synchronization with a clock signal CLK, and a latch circuit LT in the next step retains the display data taken in the shift register circuits SR1 to SRn based on a latch signal LAT and feeds the data to a gate circuit GATE in the next step. In accordance with control signals TSC, SUS, and STB fed from the control circuit (6), the gate circuit GATE performs output control of a high-voltage output circuit HOUT which outputs high driving voltages to the PDP.

Herein, when a low level “L” is inputted to the control signal TSC (tri-state control signal), both the switches SWU and SWD which are mutually connected as shown in FIG. 5 in the high-voltage output circuit HOUT are controlled to be in an OFF state, the output of the address driving circuit 5 becomes the high-impedance state, and the connected address electrode becomes the open state. When the control signal TSC is at a high level “H”, either one of the switches SWU and SWD which are mutually connected in the high-voltage output circuit HOUT is controlled to be in an ON state, and the other one is controlled to be in an OFF state. Consequently, the output of the address driving circuit 5 is maintained to a voltage of a high level (high voltage Va) or a low level (ground level) in a low-impedance state.

When the control signal TSC is at the high level “H”, all outputs of the high-voltage output circuit HOUT are controlled to a high voltage if the control signal SUS is a high level “H”, and all outputs of the high-voltage output circuit HOUT are controlled to the ground level if the control signal SUS is a low level “L”.

A control signal STB is a data enable signal of the high-voltage output circuit HOUT. When the control signal TSC is at the high level “H”, the display data retained in the latch circuit LT is outputted if the control signal STB is a high level “H”. Inversely, if the control signal STB is a low level “L”, all outputs of the high-voltage output circuit HOUT are controlled based on the control signals TSC and SUS in the manner described above.

Herein, in the conventional address driving circuit 5 shown in FIG. 6, the control signals TSC, SUS, and STB are the signals which are irrelevant to the colors of the emitted light of the cells and are used in common for all of the cells. Therefore, the PDP 2 cannot be driven by using the above-described driving waveforms shown in FIG. 4.

More specifically, the driving of the PDP 2 using the driving waveforms such as that shown in FIG. 4 is achieved by an address driving circuit as shown in FIG. 7.

As shown in FIG. 7, in an embodiment of the address driving circuit in the plasma display device according to the present invention, the control signals TSC (TSCR, TSCG, or TSCB) and input terminals thereof are provided for each color of emitted light so that the gates GATE (GATER, GATEG, or GATEB) for each color of emitted light are individually controlled. Note that, in FIG. 7, the blocks having the same functions as the blocks shown in FIG. 6 are denoted by the same reference symbols, and redundant descriptions thereof will be omitted.

As is clear from the comparison of FIG. 7 with FIG. 6, the control signal TSCR for controlling the R-cells which emit red light, the control signal TSCG for controlling the G-cells which emit green light, and the control signal TSCB for controlling the B-cells which emit blue light are inputted to the address driving circuit 5 of the present embodiment.

Moreover, in the address driving circuit 5 of the present embodiment, the gate circuit GATER for R (red), the gate circuit GATEG for G (green), and the gate circuit GATEB for B (blue) corresponding to the control signals TSCR, TSCG, and TSCB are provided, respectively. The corresponding control signals TSCR, TSCG, and TSCB and common control signals SUS and STB are fed to the gate circuits GATER, GATEG, and GATEB, respectively.

In the configuration of the address driving circuit 5 as described above, the high-impedance state and the low-impedance state (voltage Va or voltage output of the ground level) in the output of the high-voltage output circuit HOUT can be individually controlled for each of the emitted light colors of the cells. That is, when the address driving circuit 5 as shown in FIG. 7 is used, the PDP 2 can be driven by using the above-described driving waveforms shown in FIG. 4.

In the address driving circuit 5 shown in FIG. 7, the control signals TSCR, TSCG, and TSCB are inputted for each of the emitted light colors of the cells, respectively, and the gate circuits GATER, GATEG, and GATEB corresponding to them are provided, respectively. Alternatively, other configuration is also available, for example, in accordance with the firing voltages of the R-cells, the G-cells, and the B-cells, only the control signal TSC for any one of the emitted light colors is individually inputted, and the control signals TSC, SUS, and STB for other emitted light colors are inputted as common signals. In addition, although three colors of R, G, and B have been described as examples of the emitted light colors (colors of phosphors) of the cells, the colors are not limited to R, G, and B, and the number of emitted light colors of the cells is not limited to three.

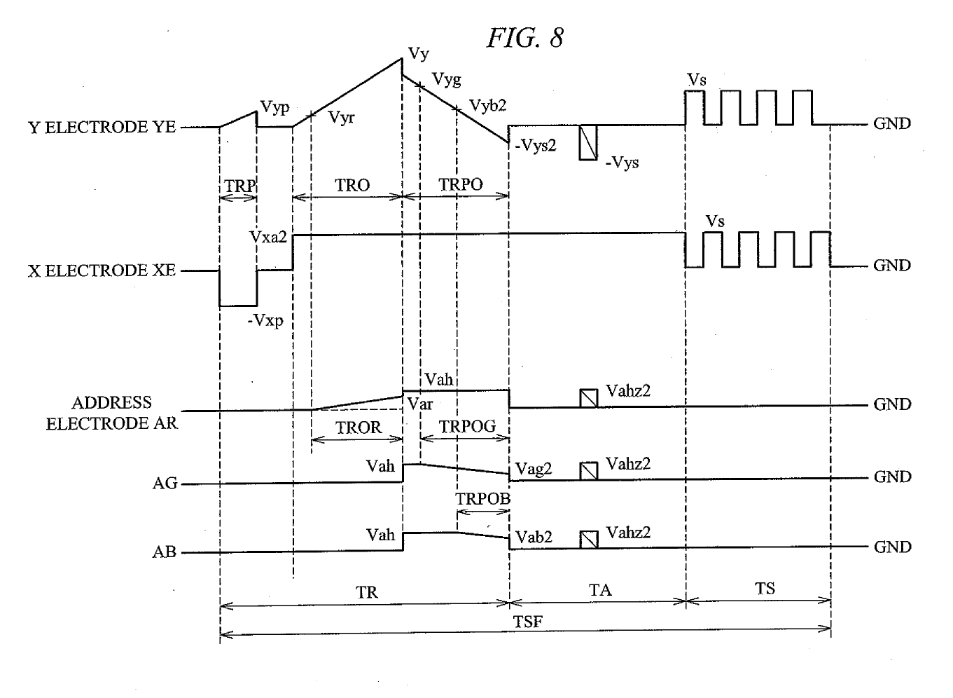

FIG. 8 is a diagram showing driving voltage waveforms in a second embodiment of the driving method of the plasma display panel according to the present invention. Note that, in FIG. 8, the same components as those in the above-described driving waveform diagram shown in FIG. 4 are denoted by the same reference symbols.

As shown in FIG. 8, in the driving method of the AC-driven PDP of the second embodiment, even in a period TRPO in the reset period TR in which the potential of the Y electrodes YE is decreased in an obtuse waveform and slight discharge is performed in both of the in-plane electrodes and the opposing electrodes, each of the address electrodes is brought into the open state so as to suppress the amount of reduced wall charge.

More specifically, in the driving method of the AC-driven PDP of the second embodiment, after the period TRO, the potentials of all of the address electrodes are switched to Vah which corresponds to the voltage-supply voltage Va in FIG. 5, and an obtuse waveform voltage which decreases to reach the potential of −Vys2 (=−Vys+Vah) which is higher than −Vys of FIG. 4 by Vah is applied to the Y electrodes YE. Moreover, the potential of the X electrodes XE is also raised to Vxa2 (=Vxa+Vah) which is higher than Vxa of FIG. 4 by Vah. By doing so, each of the address electrodes is brought into an open state with respect to slight discharge caused by the decreasing obtuse waveform of the Y electrodes YE without changing the potential relation between all of the electrodes.

Moreover, in the driving method of the AC-driven PDP of the second embodiment, by adjusting the periods TRPOG and TRPOB in the period TRPO in which the address electrodes AG and AB are brought into the open state, the wall charge amounts accumulated in the address electrodes are optimized so as to suppress the variation in the driving voltages between the address electrodes, and reduce a common address driving voltage Vahz2 to a minimum level.

Herein, in the voltage waveforms shown in FIG. 8, the voltage Vah corresponding to the power supply voltage of the driving circuits may be set to be equal to the address driving voltage Vahz2 so as to simplify the circuits. Moreover, even when the attained potentials Vag2 and Vab2 of the address electrodes AG and AB reach the ground level and a clamped state is attained, no problem occurs similarly to the above-described first embodiment. Moreover, the attained electrode Var of the address electrode AR may reach the voltage Vah and attain the clamped state.

Furthermore, the address electrode AR can have the voltage waveform represented by a broken line in FIG. 8 in which it is not in the open state in the period TRO. Also in this case, since the address electrode AR is not brought into the open state in the period TRPO, the amount of accumulated wall charge can be increased in comparison with the address electrodes AG and AB. Moreover, if slight discharge which is always uniform is surely obtained for all of the cells of the PDP, the address electrodes may be brought into the open state only by the final slight discharge TRPO.

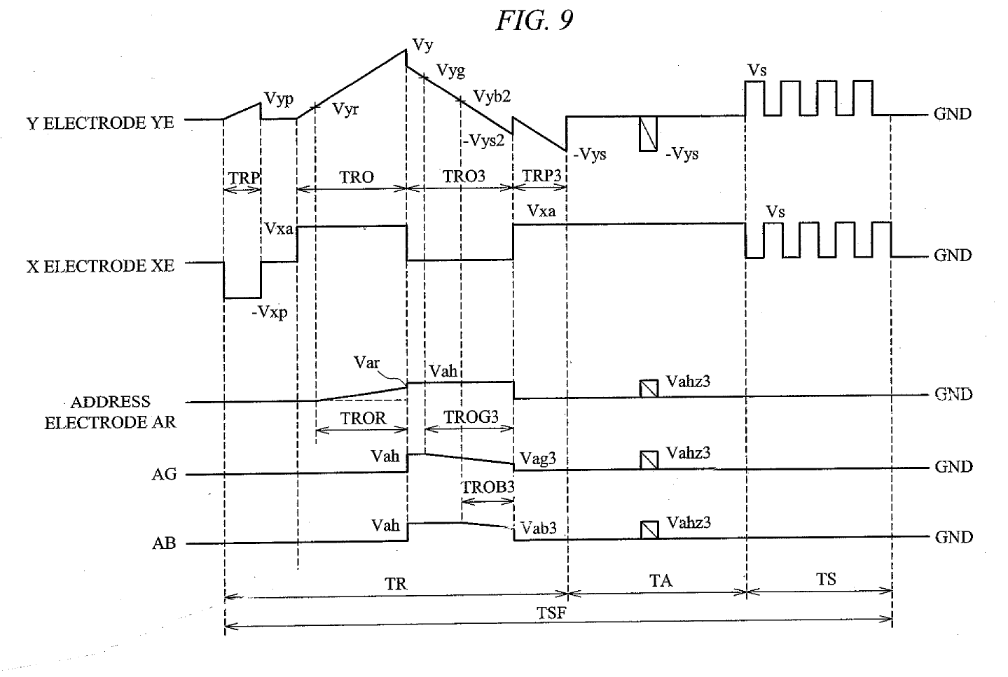

FIG. 9 is a diagram showing driving voltage waveforms in a third embodiment of the driving method of the plasma display panel according to the present invention. Note that, in FIG. 9, the same components as those in the above-described driving waveform diagrams shown in FIG. 4 and FIG. 8 are denoted by the same reference symbols.

As shown in FIG. 9, in the driving method of the AC-driven PDP of the third embodiment, the period in the reset period TR in which the potential of the Y electrode YE is decreased in the obtuse waveform is divided into a period TRO3 in which slight discharge is performed between the opposing electrodes and a period TRP3 in which slight discharge is performed between the in-plane electrodes. By doing so, the degree of freedom of the driving waveforms is improved.

In the driving method of the AC-driven PDP of the third embodiment, the voltage of the X electrodes XE is switched to the ground level and the voltage Vxa respectively in the periods TRO3 and TRP3 for the slight discharge between the opposing electrodes and between the in-plane electrodes. Consequently, interference between the slight discharge performed between the opposing electrodes and the slight discharge performed between the in-plane electrodes can be suppressed, and the degree of freedom for setting the periods in which the address electrodes are brought into the open state can be improved. In addition, the display contrast can be further improved since the amounts of the light emitted in the slight discharge can be suppressed to a minimum level. Furthermore, the power consumption of the driving circuits can be also suppressed since the driving voltages of the address electrodes, etc. can be reduced to a minimum level in addition to the driving voltage of the X electrodes XE.

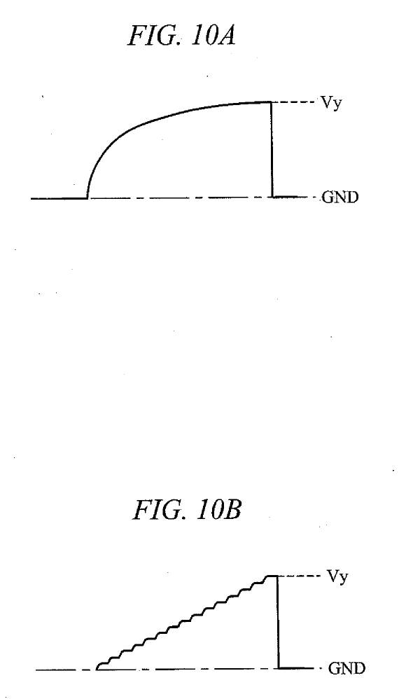

FIG. 10A and FIG. 10B are voltage waveform diagrams showing other examples of the obtuse waveforms.

In the description above, in the driving voltage waveforms in the embodiments of the driving method of the plasma display panel according to the present invention, the obtuse wave in which the voltage is varied along with the time course at a constant rate of change has been applied to the electrodes. However, the present invention is not limited to such obtuse wave in which the voltage is varied along with the time course at a constant rate of change. For example, an obtuse wave showing a voltage variation in which the rate of change of the voltage is varied along with the time course as shown in FIG. 10A, or an obtuse wave in which the voltage is varied along with the time course by alternately repeating voltage increase and voltage sustain at constant time intervals as shown in FIG. 10B can be also used.

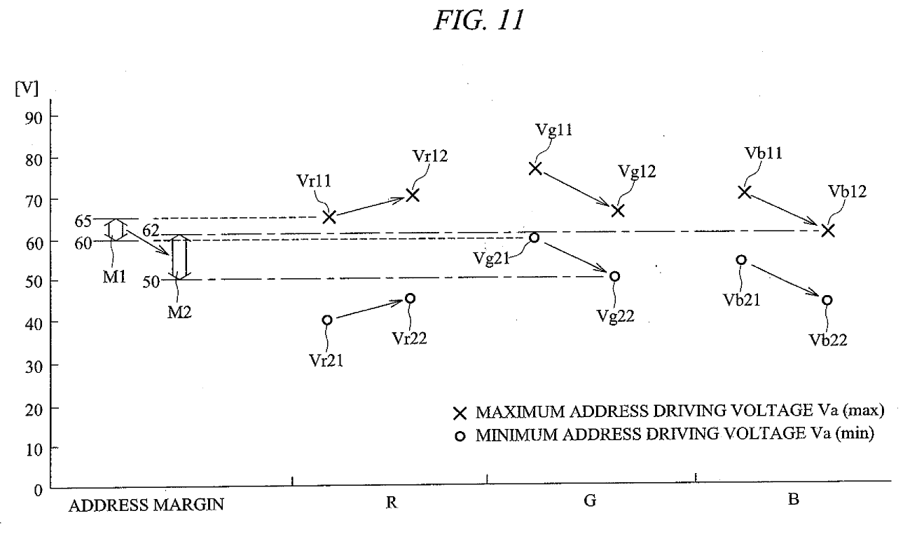

FIG. 11 is a diagram showing actual measurement examples of the address driving voltages in the plasma display device according to the present invention. In FIG. 11, the reference symbols Vr11, Vg11, and Vb11 and Vr21, Vg21, and Vb21 respectively represent maximum address driving voltages (Vamax) and the minimum address driving voltages (Vamin) of R, G, and B in a conventional plasma display device to which the present invention is not applied. Also, Vr12, Vg12, and Vb12 and Vr22, Vg22, and Vb22 respectively represent the maximum address driving voltages (Vamax) and the minimum address driving voltages (Vamin) of R, G, and B in the plasma display device to which the present invention is applied.

Incidentally, a margin of the address driving voltages is determined as a range where all voltages between the maximum address driving voltages and the minimum address driving voltages of R, G, and B are overlapped. More specifically, a margin M1 of the address driving voltages in the conventional plasma display device to which the present invention is not applied is about 60 to 65 V defined by the maximum address driving voltage (maximum address driving voltage of R) Vr11 which is the lowest among R, G, and B and the minimum address driving voltage (minimum address driving voltage of G) Vg21 which is the highest among R, G, and B.

On the other hand, a margin M2 of the address driving voltages in the plasma display device to which the present invention is applied is about 50 to 62 V defined by the maximum address driving voltage (maximum address driving voltage of B) Vb12 which is the lowest among R, G, and B and the minimum address driving voltage (lowest address driving voltage of G) Vg22 which is the highest among R, G, and B.

That is, in the driving method of the plasma display panel according to the present invention, the address driving voltages can be adjusted for each of the cells of emitted light colors. More specifically, in the experimental result of FIG. 11, the address driving voltages of the display color R are increased from Vr11 and Vr21 to Vr12 and Vr22, and the address driving voltages of other display colors G and B are reduced from Vg11 and Vg21 to Vg12 and Vg22 and from Vb11 and Vb21 to Vb12 and Vb 22, respectively. Consequently, the voltage variation between the display colors can be suppressed so as to significantly increase the address voltage margin from M1 (about 60 to 65 V) to M2 (about 50 to 62 V), and the voltage level can be reduced.

Although an arbitrary voltage within the margin M2 can be used for actual address driving, a comparatively lower voltage within the margin M2 (for example, about 53 V) is used in consideration for some allowance for temperature variation, production variation, etc. Therefore, for example, if the address driving voltage of the conventional plasma display device to which the present invention is not applied is set to 63 V (wherein margin M1 is about 60 to 65 V), since the plasma display device to which the present invention is applied can be driven with the address driving voltage of 53 V (wherein the margin M2 is about 50 to 62 V) and ( 53/63)²=0.7, the power consumption of the address driving circuit can be reduced by about 30%. Moreover, since light emission in the slight discharge and before and after that in the reset period can be suppressed to a minimum level, the display quality can be improved through the reduction of the background light emission in the PDP, and, for example, the display contrast can be readily increased to 3000 or more.

(Note 1)

In a driving method of a plasma display panel having a plurality of first electrodes provided so as to correspond to phosphors of a plurality of emitted light colors and having a plurality of second electrodes disposed so as to intersect with the first electrodes,

the first electrodes for each of the emitted light colors that are provided so as to correspond to at least one of the phosphors of the emitted light colors among the first electrodes are brought into an electrically open state at a part of a driving timing in a driving period.

(Note 2)

In the driving method of the plasma display panel according to note 1,

the first electrodes for each of the emitted light colors are brought into the electrically open state and driven in at least two periods in accordance with types of the phosphors of the respective emitted light colors.

(Note 3)

In the driving method of the plasma display panel according to note 1,

the first electrodes are address electrodes provided so as to correspond to the phosphors of three primary colors of red, green, and blue.

(Note 4)

In the driving method of the plasma display panel according to note 1,

the part of the driving timing for bringing the first electrodes for each of the emitted light colors into the electrically open state is a driving timing in a reset period.

(Note 5)

In the driving method of the plasma display panel according to note 4,

the first electrodes for each of the emitted light colors are brought into the electrically open state at the timing at which positive wall charge is increased in the first electrodes in the reset period.

(Note 6)

In the driving method of the plasma display panel according to note 4,

the first electrodes for each of the emitted light colors are brought into the electrically open state at the timing at which positive wall charge is reduced in the first electrodes in the reset period.

(Note 7)

In the driving method of the plasma display panel according to note 4,

the first electrodes for a first emitted light color are brought into the electrically open state at the timing at which positive wall charge is increased in the first electrodes in the reset period, and

the first electrodes for a second emitted light color are brought into the electrically open state at the timing at which positive wall charge is reduced in the first electrodes in the reset period.

(Note 8)

In a driving method of a plasma display panel having a plurality of first electrodes provided so as to correspond to phosphors of a plurality of emitted light colors and having a plurality of second electrodes disposed so as to intersect with the first electrodes,

wall charge generated in the first electrodes is independently controlled for each of the emitted light colors.

(Note 9)

In the driving method of the plasma display panel according to note 8,

the control of the wall charge generated in the first electrodes for each of the emitted light colors is performed by bringing the first electrodes for at least one of the emitted light colors into an electrically open state in a part of a reset period.

(Note 10)

In the driving method of the plasma display panel according to note 9,

the control of the wall charge generated in the first electrodes for each of the emitted light colors is performed by bringing the first electrodes into the electrically open state at the timing at which positive wall charge is increased in the first electrodes in the reset period.

(Note 11)

In the driving method of the plasma display panel according to note 9,

the control of the wall charge generated in the first electrodes for each of the emitted light colors is performed by bringing the first electrodes into the electrically open state at the timing at which positive wall charge is reduced in the first electrodes in the reset period.

(Note 12)

In the driving method of the plasma display panel according to note 9,

the control of the wall charge generated in the first electrodes for a first emitted light color is performed by bringing the first electrodes into the electrically open state at the timing at which positive wall charge is increased in the first electrodes in the reset period, and

the control of the wall charge generated in the first electrodes for a second emitted light color is performed by bringing the first electrodes into the electrically open state at the timing at which positive wall charge is reduced in the first electrodes in the reset period.

(Note 13)

In the driving method of the plasma display panel according to any one of notes 5, 7, 10, and 12,

the first electrodes are brought into the electrically open state at the timing at which positive wall charge is increased in the first electrodes while an obtuse wave in which a first predetermined voltage gradually increases to finally reach a second predetermined voltage is being applied to the first electrodes in the reset period.

(Note 14)

In the driving method of the plasma display panel according to any one of notes 6, 7, 11, and 12,

the first electrodes are brought into the electrically open state at the timing at which positive wall charge is reduced in the first electrodes while an obtuse wave in which a third predetermined voltage gradually decreases to finally reach a fourth predetermined voltage is being applied to the first electrodes in the reset period.

(Note 15)

In a driving circuit of a plasma display panel having a plurality of output terminals for driving a plasma display panel having a plurality of first electrodes provided so as to correspond to phosphors of a plurality of emitted light colors and having a plurality of second electrodes disposed so as to intersect with the first electrodes,

only driving elements connected to a plurality of the output terminals connected to the first electrodes for each of the emitted light colors in the driving circuit are controlled to be in a high-impedance state so that the first electrodes for each of the emitted light colors that are provided so as to correspond to at least one of the phosphors of the emitted light colors among the first electrodes are brought into an open state.

(Note 16)

In the driving circuit of the plasma display panel according to note 14,

the first electrodes for each of the emitted light colors are connected to the output terminals which are repeatedly arranged so as to correspond to the number of the emitted light colors, and

the driving circuit is formed as an integrated circuit for controlling only the driving elements, which are connected to the repeatedly-arranged output terminals in the driving circuit, to be in the high-impedance state.

(Note 17)

In the driving circuit of the plasma display panel according to note 14,

input terminals corresponding to the number of the emitted light colors corresponding to the repeatedly-arranged output terminals are provided.

(Note 18)

In the driving circuit of the plasma display panel according to note 16,

the plurality of phosphors of the emitted light colors are phosphors of three primary colors of red, green, and blue, and

the driving circuit is an integrated circuit for controlling the driving element groups which are connected in driving circuit groups of three output terminal groups, in which a pair of adjacent output terminals are repeatedly arranged, to be in the high-impedance state in accordance with control signals applied to three types of input terminals.

(Note 19)

In a driving circuit of a plasma display panel having a plurality of first electrodes provided so as to correspond to phosphors of a plurality of emitted light colors and having a plurality of second electrodes disposed so as to intersect with the first electrodes,

the driving method of the plasma display panel according to any one of notes 1 to 14 is applied.

(Note 20)

In a plasma display device comprising: a plasma display panel having a plurality of first electrodes provided so as to correspond to phosphors of a plurality of emitted light colors and having a plurality of second electrodes disposed so as to intersect with the first electrodes,

the plasma display panel is driven by bringing the first electrodes for each of the emitted light colors that are provided so as to correspond to at least one of the phosphors of the emitted light colors among the first electrodes into an electrically open state at a part of a driving timing in a driving period.

(Note 21)

In a plasma display device comprising: a plasma display panel having a plurality of first electrodes provided so as to correspond to phosphors of a plurality of emitted light colors and having a plurality of second electrodes disposed so as to intersect with the first electrodes; and a driving circuit having a plurality of output terminals for driving the plurality of first electrodes,

the driving circuit controls only driving elements connected to a plurality of the output terminals connected to the first electrodes for each of the emitted light colors in the driving circuit to be in a high-impedance state so that the first electrodes for each of the emitted light colors that are provided so as to correspond to at least one of the phosphors of the emitted light colors among the first electrodes are brought into an open state.

(Note 22)

A plasma display device comprises: a plasma display panel having a plurality of first electrodes provided so as to correspond to phosphors of a plurality of emitted light colors and having a plurality of second electrodes disposed so as to intersect with the first electrodes; and

the driving circuit of the plasma display panel according to any one of notes 15 to 19.

The present invention can be widely applied to plasma display devices. For example, it can be applied to plasma display devices which are utilized as display devices of personal computers, workstations, etc., flat-type wall-hung TVs, and devices for displaying advertisements, information, etc.

What is claimed is:

1. A driving method of a plasma display panel having a plurality of first electrodes provided so as to correspond to phosphors of a plurality of emitted light colors and having a plurality of second and third electrodes disposed so as to intersect with the first electrodes, in which a reset period, an address period and a sustain discharge period are provided,
wherein, in the reset period, a first slope waveform in which an applied voltage value is increased with time course is applied to the second electrodes, a second slope waveform in which an applied voltage value is decreased with time course is next applied to the second electrodes, and after the voltage is risen to a predetermined voltage value, a third slope waveform in which an applied voltage value is decreased with time course is applied to the second electrodes, and
an attained voltage value of the third slope waveform is lower than an attained voltage value of the second slope waveform.

2. The driving method of a plasma display panel according to claim 1, wherein the first electrodes for each of the emitted light colors that are provided so as to correspond to at least one of the phosphors of the emitted light colors among the first electrodes are brought into an electrically open state in a second period which is a part of a period in which the second slope waveform is applied to the second electrodes.

3. The driving method of a plasma display panel according to claim 1, wherein a ground voltage value is applied to the third electrodes during a period when the second slope waveform is applied to the second electrodes, and
a positive voltage value is applied to the third electrodes during a period when the third slope waveform is applied to the second electrodes.

4. The driving method of a plasma display panel according to claim 2, wherein a ground voltage value is applied to the third electrodes during a period when the second slope waveform is applied to the second electrodes, and
a positive voltage value is applied to the third electrodes during a period when the third slope waveform is applied to the second electrodes.

5. The driving method of a plasma display panel according to claim 2, wherein the first electrodes for each of the emitted light colors that are provided so as to correspond to at least one of the phosphors of the emitted light colors among the first electrodes are brought into an electrically open state in a first period which is a part of a period in which the first slope waveform is applied to the second electrodes.

6. The driving method of a plasma display panel according to claim 5, wherein the first electrodes to be brought into an electrically open state in the first period and the first electrodes to be brought into an electrically open state in the second period are the first electrodes provided so as to correspond to the phosphors of the same emitted light color.

7. The driving method of a plasma display panel according to claim 4, wherein the first electrodes for each of the emitted light colors that are provided so as to correspond to at least one of the phosphors of the emitted light colors among the first electrodes are brought into an electrically open state in a first period which is a part of a period in which the first slope waveform is applied at the second electrodes.

8. The driving method of a plasma display panel according to claim 7, wherein the first electrodes to be brought into an electrically open state in the first period and the first electrodes to be brought into an electrically open state in the second period are the first electrodes provided so as to correspond to the phosphors of the same emitted light color.
